(19) United States
(12) Patent Application Publication
(10) Pub. No.: US 2003/0165411 A1
(43) Pub. Date: Sep. 4, 2003

(54) Compact ozone generator

(76) Inventor: Rolf Engelhard, Prescott, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/349,346

(22) Filed: Jan. 22, 2003

Related U.S. Application Data
(60) Provisional application No. 60/351,446, filed on Jan. 23, 2002.

(51) Int. Cl. B01J 19/08; B01J 19/12

(52) U.S. Cl. 422/186.07; 204/164

(57) ABSTRACT

A module containing a pair of generally concentric cylinders with a dielectric cylinder disposed therebetween is connected to a source of air under pressure to provide an air flow intermediate the concentric cylinders and on either side of the encircled dielectric cylinder. Clips, connected to a source of high voltage, detachably engage the outer cylinder and a boss electrically connected to the inner cylinder to provide a voltage potential between the generally concentric cylinders of sufficient magnitude to cause an electrostatic discharge through the space therebetween. The use of an electrically high resistance dielectric cylinder between the generally concentric cylinders will tend to provide a uniform electrostatic discharge along the length of the generally concentric cylinders. The oxygen molecules within the air flow between the generally concentric cylinders will be converted, to some extent, to ozone molecules and provide an ozone enriched air flow into a plenum and an outflow therefrom through tubing to a point of use. As the module is readily detached from its mechanically and electrically associated clips, it is readily replaced in the event of malfunction. Moreover, the electrically conducting cylinders may be of inexpensive metallic tubing and the dielectric cylinder may be inexpensive glass tubing. The electric circuitry providing a voltage potential sufficient to produce electrostatic discharge is primarily an inexpensive step-up transformer.

### CROSS-REFERENCE TO RELATED APPLICATIONS

The present application includes subject matter contained in and claims priority to the subject matter disclosed in a provisional application entitled “Ozone Generator” filed Jan. 23, 2002 and assigned Ser. No. 60/351,446 directed to an invention made by the present inventor.

### BACKGROUND OF THE INVENTION

An ozone generator is a device for producing ozone (O₃) from a source of oxygen by subjecting the oxygen to a high voltage electrostatic discharge. For example, a lightning strike produces ozone and the distinctive smell of ozone can be sensed if one is reasonably close to the lightning strike.

Ozone can also be created by irradiating a source of oxygen, such as air, with ultraviolet light. Various devices of this type have been available for decades. One of the problems with irradiating a source of air with ultraviolet radiation is the expense of the lamp which must have an envelope that is transparent to ultraviolet radiation, such as quartz. Lamps of this type are relatively expensive. Furthermore, these lamps do bum out or otherwise cease functioning for a multitude of reasons. When such malfunction occurs, the lamp must be replaced, which is generally a cumbersome and time-consuming endeavor. Moreover, such replacement generally requires a skilled technician as it may be dangerous and/or difficult for a layman to perform such maintenance/repair.

Devices for producing ozone by producing an electrical discharge in the presence of an oxygen conveying gas, such as air, have been available for decades. Such devices are generally large and cumbersome. Moreover, they are usually expensive to obtain. Furthermore, they are generally expensive to maintain, not only because of the costs of the replacement parts but the skill required generally demands that a skilled technician perform all maintenance and repair work.

Ozone is an unstable powerful bleaching and oxidizing agent and is used to purify and deodorize air as well as to sterilize water. It is often used in solution as a viricide and bactericide in medical and quasi medical applications. Relatively recently it has been introduced as a gas into aquariums with pronounced results over that of conventional aerators. However, ozone generators presently available are too bulky and too expensive for general home use in aquariums as well as in other applications wherein the oxidizing properties of ozone would be beneficial.

### BRIEF SUMMARY OF THE INVENTION

The ozone generator of the present invention is a module having a threaded shaft serving as an electrode and which mechanically secures the various elements with one another. A first generally concentric cylinder of electrically conducting material is in electrical contact with the threaded shaft. A generally concentric cylinder of dielectric material envelopes the first concentric cylinder in spaced apart relationship. A second generally concentric cylinder of electrically conducting material envelopes the dielectric cylinder in spaced apart relationship. Air inflow is channeled between the first and second cylinders on either side of the dielectric cylinder and may exhaust through the cylindrical space within the first cylinder and about the threaded shaft. High voltage electrical power is provided by electric circuitry through a pair of clips, one of them engaging a boss electrically connected to the threaded shaft, which shaft is in electrical contact with the first cylinder, and the other clip engaging the external surface of the second cylinder. As the air passes intermediate the first and second cylinders, it is subjected to an electrostatic discharge and ozone is produced. By use of these clips, the module can be readily replaced by disengaging it from the clips and re-engaging a replacement module. Necessarily, the tubing conveying the air to the module and the ozonated air from the module must first be disconnected and subsequently reconnected. The size of the module may be relatively small and mounted within a small container also having the electrical components for generating the electrostatic discharge located therein. To increase the space for generating ozone, additional concentric cylinders may be incorporated.

It is therefore a primary object of the present invention is to provide a replaceable module for generating ozone.

Another object of the present invention is to provide a removably mounted ozone generator within a compact container also enclosing electrical components necessary to create an electrostatic discharge within the ozone generator.

Yet another object of the present invention is to provide a pair of generally concentric cylinders serving as the electrodes for generating an electrostatic discharge within air disposed therebetween to produce ozone enriched air.

Still another object of the present invention is to provide an ozone generator module constructed of inexpensive easily available materials.

A further object of the present invention is to provide an ozone generator module having a plurality of concentrically mounted pairs of electrodes for generating an electrostatic discharge to produce ozone in an oxygen containing gas passing therethrough.

A yet further object of the present invention is to provide an inexpensive throw-away module for generating ozone.

A still further object of the present invention is to provide a method for inexpensively generating ozone.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a container for housing a replaceable ozone generator module and the electrical components necessary to produce an electrostatic discharge;

FIG. 2 is an end view taken along lines 2-2, as shown in FIG. 1;

FIG. 3 is an end view taken along lines 3-3, as shown in FIG. 1;

FIG. 4 illustrates an exploded view of the ozone generator module;

FIG. 5 is a cross-sectional view taken along lines 5-5, as shown in FIG. 4;

FIG. 6 is a cross-sectional view taken along lines 6-6, as shown in FIG. 5;

FIG. 7 is a cross-sectional view of a variant of the ozone generator module;

FIG. 8 is a cross-sectional view taken along lines 8-8, as shown in FIG. 7;

FIG. 9 is a cross-sectional view taken along lines 9-9, as shown in FIG. 7;

FIG. 10 is an end view taken along lines 10-10, as shown in FIG. 7;

FIG. 11 illustrates a further variant of the ozone generator;

FIG. 12 is an end view taken along lines 12-12, as shown in FIG. 11;

FIG. 13 is a cross-sectional view taken along lines 13-13, as shown in FIG. 11; and

FIG. 14 illustrates a yet further variant showing three cylinders of electrically conductive material forming two pairs of concentric electrodes for generating ozone.

### DESCRIPTION OF THE INVENTION

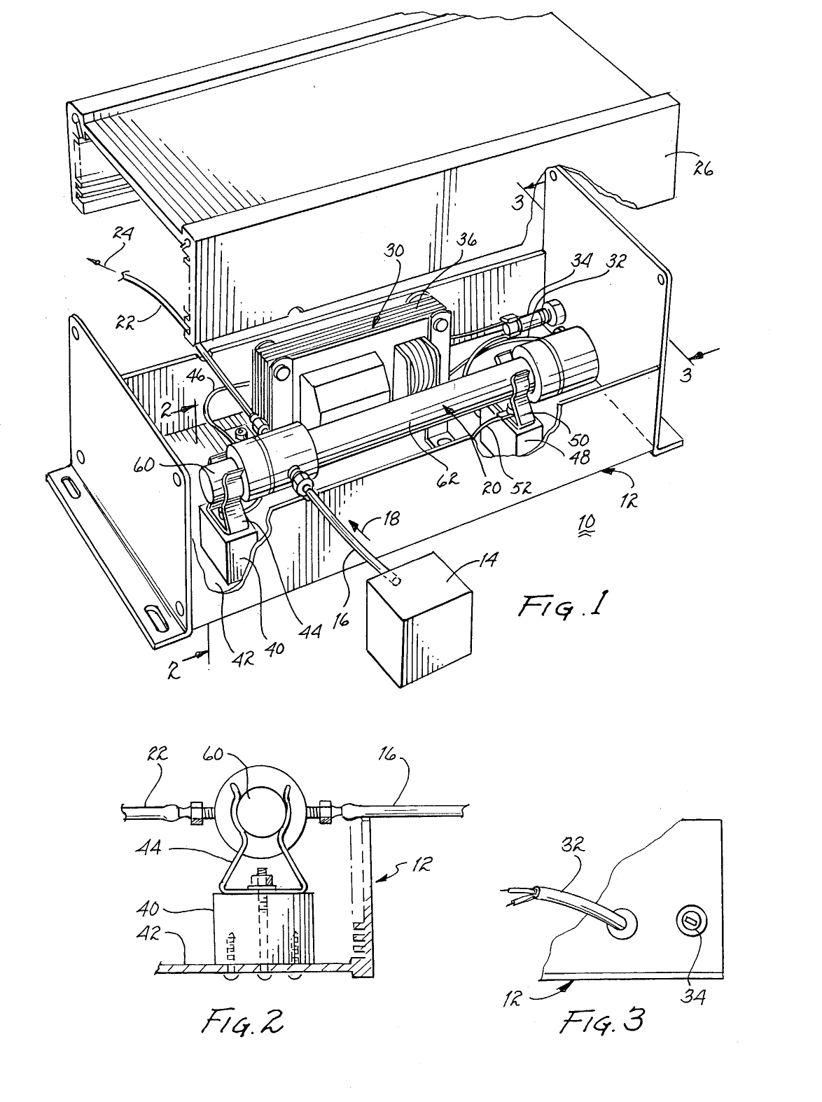

Referring to FIGS. 1, 2 and 3 there is illustrated an ozone generator 10 housed within a container 12. An air pump 14 delivers a supply of air through tubing 16, as depicted by arrow 18, to a module 20. The module includes the operative elements for generating ozone upon application of electrical power and as a result of air passing therethrough. The ozone enriched air is discharged through tubing 22, as depicted by arrow 24. A cover 26 is removably formed as part of container 12 to permit any necessary maintenance of the components within the container and for replacement of module 20 when required. Electric circuitry 30 for creating an electrostatic discharge within module is housed within container 12. The electric circuitry includes an electrical conductor 32 adapted to be connected to a source of electrical power, a fuse 34 and a transformer 36. A pedestal 40 is mounted upon base 42 of the container and supports a clip 44. The clip is electrically connected to the output of electric circuitry 30 via an electrical conductor 46. A similar pedestal 48 is mounted upon and extends upwardly from base 42 and supports a further clip 50. This clip is electrically connected to electric circuitry 30 via an electrical conductor 52. Module 20 includes a stud or boss 60 of electrically conducting material and extends from one end of the module. Clip 44 supports the boss and electrically interconnects the module with electrical circuitry 30. The module includes a hollow tube or cylinder 62 of electrically conducting material, such as inexpensive metallic tubing. Cylinder 62 is supported by and electrically connected to clip 50. Thereby, module 20 is secured within container 12 by clips 44,50 and is easily replaceable.

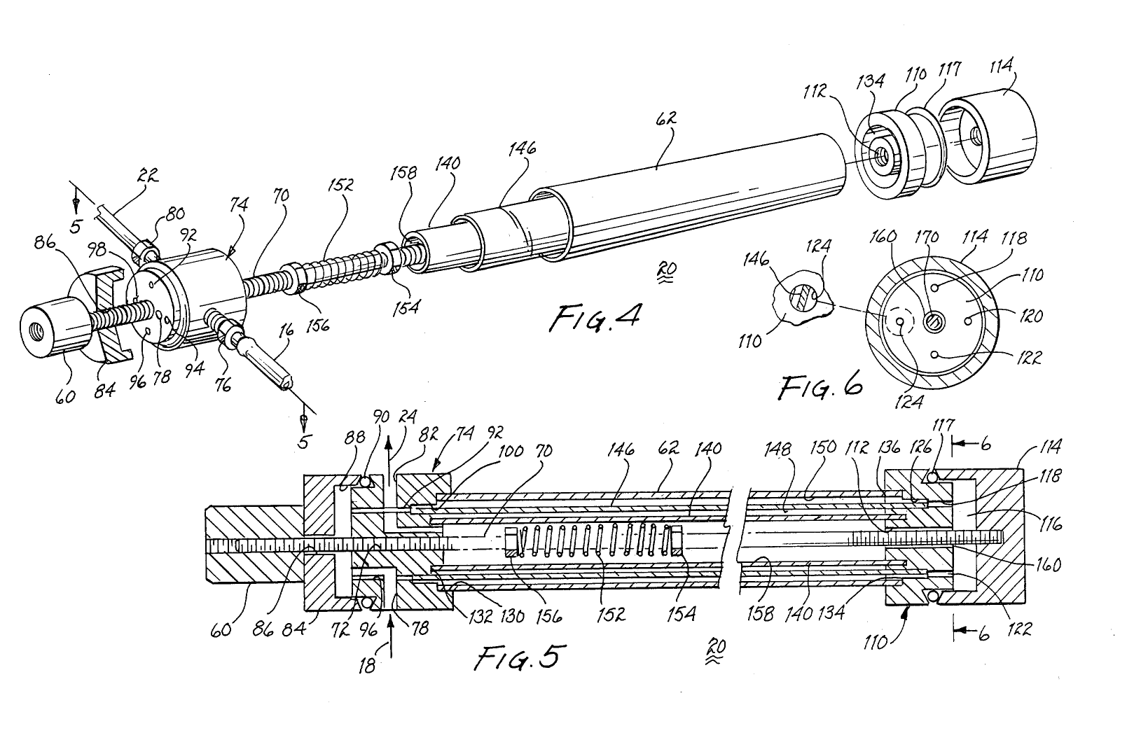

Referring jointly to FIGS. 4, 5, and 6, details of the structure of module 20 will be described. A threaded rod 70 of electrically conductive material slidably engages a passageway 72 extending through block 74. A nipple 76 supports tubing 16 and is threaded engagement with passageway 78 in block 74. Thereby, air is conveyed to and through the block. A further nipple 80 supporting tubing 22 is in threaded engagement with passageway 82 in block 74. An end cap 84 penetrably and slidably receives threaded rod 70 through passageway 86. Upon mounting end cap 84 upon the threaded rod adjacent block 74, a plenum 88 is formed therebetween. To seal the end cap with the block, an O-ring 90 may be employed, as illustrated. It is noted that passageway 78, conveying air into module 20, is in fluid communication with plenum 88. One or more passageways 92, 94, 96, 98 (see also FIG. 4) are in fluid communication with plenum 88 and extend through block 74 to a hollow annular ring 100. Block 110 penetrably and slidably receives threaded rod 70 through passageway 112. An end cap 114 is in threaded engagement with threaded rod 70 and bears against block 110 to form a plenum 116 therebetween.

The integrity of plenum 116 is maintained by O-ring 117, or the like, inserted between end cap 114 and block 110. A plurality of passageways 118, 120, 122 and 124 (see also FIG. 6) extend through block 110 from plenum 116 to a hollow annular ring 126. An annular depression 130 of annular ring 100 is formed in block 74. This depression may include a stepped base 132, as illustrated in FIG. 5. A corresponding annular depression 134 of annular ring 126 is formed in block 110. Annular depression 134 may also include a stepped base 136, as illustrated. Passageways 92, 94, 96 and 98 are in fluid communication with annular ring 100. Similarly, passageways 118, 120, 122 and 124 are in fluid communication with annular ring 126. A tube or cylinder 140 of electrically conductive material, such as inexpensive metallic tubing, is mounted in each of annular depressions 130,134 and may be supported adjacent the inner radial wall, as illustrated. Cylinder 62 is also supported in each of annular depressions 130,134 and may be adjacent the radially outward radial wall of the annular depressions, as illustrated. If stepped bases are formed in the respective annular depressions, one of the cylinders would rest upon one of the bases and the other cylinder would rest upon another of the bases. A dielectric cylinder 146 of dielectrical material, such as inexpensive glass tubing, is supported in annular rings 100, 126. The dielectric cylinder is disposed intermediate and generally concentric with cylinders 62, 140. Such location provides a cylindrical air space 148 between cylinder 140 and dielectric cylinder 146 and a further cylindrical air space 150 between the dielectric cylinder and cylinder 62. A coil spring 152 encircles threaded rod 70 between nuts 154,156 in threaded engagement with the threaded rod. By tightening the nuts, the coil spring will tend to assume a wave-like configuration and thereby come into electrical contact with inner surface 158 of cylinder 140 and electrical contact is thereby established between the threaded rod and cylinder 140.

Assembly of module 20 may be accomplished as follows. Threaded rod 170 is brought into threaded engagement with end cap 114. Block 110 is slipped onto the threaded rod along with O-ring 117 to be located between the end cap and the block. Cylinder 140 is slipped onto the threaded rod and seated within annular depression 134. Similarly, dielectric cylinder 146 and cylinder 62 are slipped on in generally concentric relationship with cylinder 140 and seated in annular ring 126 and annular depression 134, respectively. Block 74 is slipped onto the threaded rod to nest cylinders 140, 62 and dielectric cylinder 146, in annular depression 130 and annular ring 142, respectively. O-ring 90 and end cap 84 are slipped over the threaded rod and into engagement with block 74. Boss 60 is brought into threaded engagement with threaded rod 70 to compress the end caps against their respective blocks and to secure each of the cylinders between the blocks.

Inflowing air, as represented by arrow 18, flows through block 74 into plenum 88. From the plenum, the air flows through each of passageways 92, 94, 96 and 98 into annular ring 100 and annular depression 130. Thence, the air flows on either side of dielectric cylinder 146 and between cylinders 62, 140 into annular depression 134 and annular ring 126 in block 110. From there, the air flows through each of passageways 118, 120, 122 and 124 into plenum 116. The air from plenum 116 is exhausted through annular space 160 surrounding threaded rod 70 within block 110 into the interior space defined by inner surface 158 of the cylinder 140 and into passageway 82 in block 74. It is exhausted from block 74 through passageway 82, as represented by arrow 24.

Cylinder 140 is electrically connected to clip 44 via spring 152, nuts 154,156, threaded rod 70 and boss 60 engaged by clip 44. Clip 50 directly electrically engages cylinder 62. Upon energization of electric circuitry 30, a substantial potential difference will be present between cylinder 140 and cylinder 62. This potential difference is sufficient to create an electrostatic discharge therebetween. The presence of dielectric cylinder 146 creates a uniform high resistance between the inner and outer cylinders to urge even distribution of electrical discharges along the cylinders. The electrostatic discharges through the air flowing intermediate cylinders 140, 62 will result in some of the oxygen molecules being converted to ozone molecules. Accordingly, the air outflow from block 74 into tubing 22, will be ozone enriched air.

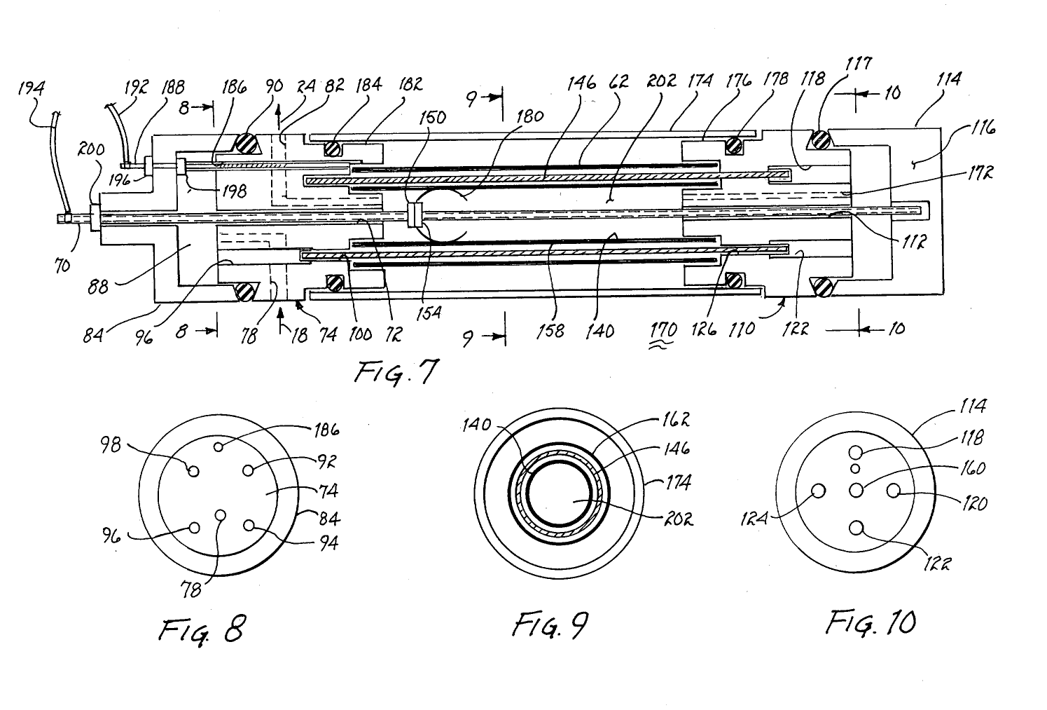

Referring jointly to FIGS. 7, 8, 9 and 10, an ozone generator variant module 170, similar to module 20, will be described. Elements essentially the same as or comparable with corresponding elements discussed with respect to module 20 will be given the same reference numerals. End cap 114 is in threaded engagement with threaded rod 70, which threaded rod also supports block 110. Block 110 is similar to that described with respect to module 20 but includes certain differences, which will be now discussed. A passageway 172 extends through the block to provide fluid communication between plenum 116 and the space interior of cylinder 140. A sleeve 174 is supported upon block 110 coincident with an annular indentation 176. A seal between the block and the sleeve is provided by an O-ring 178. Electrical connection between threaded rod 70 and cylinder 140 may be provided by a clip 180 mounted upon the threaded rod and between nuts 154,156 to extend radially and bear against surface 158 of the cylinder to make good electrical contact.

Block 74, penetrably mounted on threaded rod 70, includes an annular indentation 182 to receive and support the end of sleeve 174. The junction therebetween may be sealed with an O-ring 184. A passageway 186 extends through the block for receiving a rod 188 (or other electrical conductor) in electrical contact with cylinder 62. A high voltage is impressed upon cylinder 62 and threaded rod 70 via respective electrical conductors 192,194 connected to electric circuitry 30 (see FIG. 1). A pair of nuts 196,198 may be employed to secure rod 188 with end cap 84 to maintain it in electrical contact with cylinder 62; or, if such electrical contact is essentially solid/permanent, to support the end of the rod extending from end cap 84. A nut 200 is in threaded engagement with rod 70 and bears against end cap 84 to maintain the various components compressed between the respective end caps.

In operation, air is introduced, as depicted by arrow 18, through passageway 78 into plenum 88. From the plenum, the air passes through a plurality of passageways 92, 94, 96 and 98 on each side of dielectric cylinder 146 and between cylinders 140, 62. The air is conveyed therefrom through a plurality of passageways 118, 120, 122 and 124 into plenum 116. The air is exhausted from plenum 116 through passageway 172 and through passageway 112 encircling a threaded rod 70 and into cylindrical space 202. The air is exhausted from the cylindrical space through passageway 82, as depicted by arrow 24. As the air passes between cylinders 140, 62, it will be subjected to repetitive electrostatic discharges as a result of the high potential therebetween. Such electrostatic discharges will convert oxygen molecules to ozone molecules. The resulting air with entrained ozone molecules will be exhausted through passageway 82. To prevent leakage of air around the ends of cylinders 140, 62, the cylinders may be in sealed engagement with blocks 74,110. However, sleeve 174 encircling these cylinders and being in sealed engagement with the blocks will preclude an escape of air other than through passageway 82. Thus, sealing of the individual cylinders is not critical to operation of variant module 170 since at least most of the air flowing thereinto will be subjected to electrostatic discharges to create ozone.

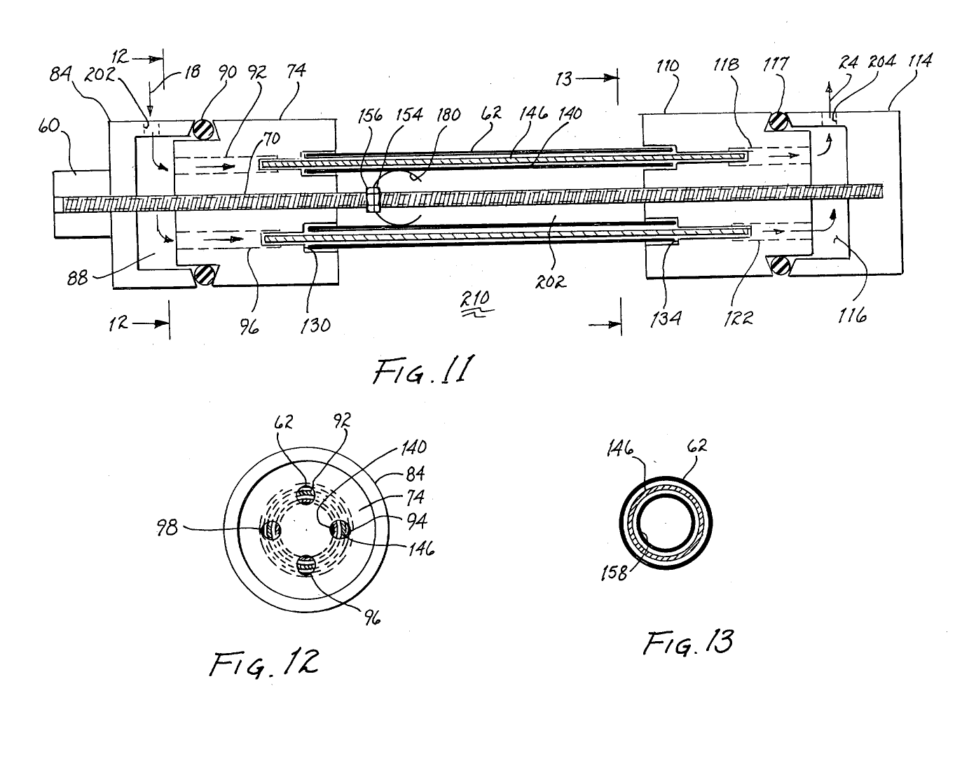

FIGS. 11, 12 and 13 jointly illustrate a further variant 210 of the ozone generator. For convenience and brevity, numerals relating to structure common with previously described elements will be retained. Air to be ozonated enters end cap 84 through passageway 202 into plenum 88, as depicted by arrow 18. The air within the plenum flows through passageways 92, 94, 96 and 98 into the space between outer cylinder 62 and inner cylinder 140 on either side of dielectric cylinder 146. The air exhausts therefrom through passageways 118, 120, 122, and 124 (see also FIG. 6) into plenum 116 within end cap 114. The ozonated air exhausts through passageway 204, as depicted by arrow 24.

In this embodiment, cylinders 62 and 140 are preferably in sealed engagement with blocks 74 and 110 to prevent air leakage outside of variant module 210. Such sealing is readily accomplished with a mastic or adhesive of some type. Alternatively, sufficient sealing may be accomplished if cylinders 62, 140 have a tight or press fit within annular depressions 130, 134.

As described with respect to module 20 and illustrated in FIG. 1, variant module 210 may be connected to electric circuitry 30 by clip 44 engaging boss 60 and clip 50 engaging the exterior of cylinder 62. Upon application of a relatively high voltage between cylinders 62, 140, and a flow of air into plenum 88, the air flowing in between the cylinders will be subjected to electrostatic discharges. Such electrostatic discharges will convert some oxygen molecules into ozone molecules. Thereby, the air exhausting from plenum 116 will be ozone enriched.

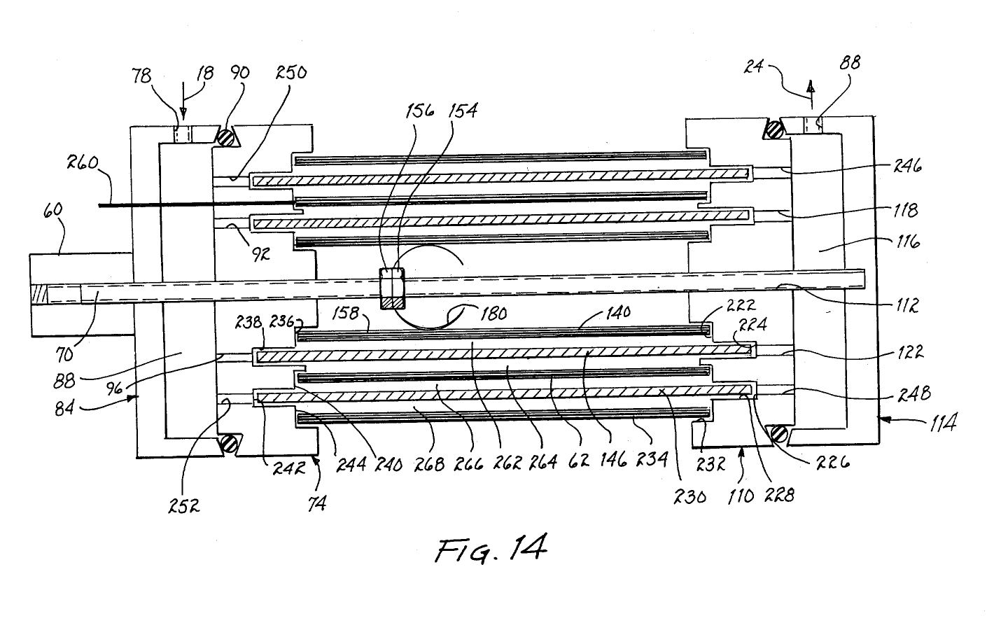

FIG. 14 illustrates a yet further variant module 220 for generating ozone. In the following description, parts or elements common with previously described functionally equivalent elements will be given common reference numerals. Threaded rod 70 threadedly engages end cap 114 and block 110 is supported on the treaded rod by penetrable engagement with passageway 112. The block includes an annular recess 222 for receiving one end of cylinder 140. A further hollow annular ring 224 receives one end of dielectric cylinder 146 and another annular recess 226 receives one end of cylinder 62. A further hollow annular ring 228 receives dielectric cylinder 230 and a further annular recess 232 receives one end of cylinder 234. Block 74 includes similar annular rings and recesses; specifically, annular recess 236 receives an end of cylinder 140, annular ring 238 receives an end of dielectric cylinder 146, annular recess 240 receives an end of cylinder 62, annular ring 242 receives an end of dielectric cylinder 230 and annular recess 244 receives an end of cylinder 234.

A plurality of passageways, of which passageways 118, 122 are shown, interconnect annular ring 244 with plenum 116 defined by end cap 114. A plurality of passageways, of which passageways 246, 248 are shown, interconnect annular ring 224 with plenum 116. These passageways and the passageways described below may be equiangularly spaced about threaded rod 70, as shown, for instance, in FIG. 10. A plurality of passageways, of which passageways 92, 96 are shown, interconnect annular ring 238 with plenum 88 in end cap 84. A plurality of further passageways, of which passageways 250, 252 are shown, interconnect annular ring 242 with plenum 88.

As described above with respect to the module shown in FIG. 7 and 10, clip 180 is secured to threaded rod 70 by nuts 154, 156 to establish electrical contact between the threaded rod and surface 158 of cylinder 140. Boss 60, in threaded engagement with the threaded rod, is captured by clip 44 (see FIG. 1) to connect the threaded rod to one conductor of electric circuitry 30, such as conductor 46. The exterior surface of cylinder 234 is engaged by a clip equivalent to clip 50 to electrically interconnect cylinder 234 with electric circuitry 30; as cylinders 140 and 234 are at the same voltage potential, clip 50 is also connected to conductor 46. A conductor 260 is in electrical contact with cylinder 62. This conductor may extend through block 74 and end cap 84, as illustrated. Preferably, the fit of the electrical conductor within the block and the end cap is sufficiently tight to minimize air flow therepast. As cylinder 62 is intermediate cylinders 140, 234 and to establish voltage difference therebetween, conductor 260 is in electrical contact with conductor 52 of electric circuitry 30. A clip equivalent to clip 50 (see FIG. 1), is electrically connected in parallel with clip 44, as set forth above. Clip 44 detachably clips onto boss 60 and the equivalent of clip 50 detachably clips onto cylinder 234. Thereby, cylinders 140 (via clip 180 and threaded rod 70) and cylinder 234 are at essentially the same voltage. An electrical conductor, equivalent to electrical conductor 52 shown engaged with clip 50 in FIG. 1 is connected to conductor 260. Thereby, cylinder 62 is at a voltage potential different from that of cylinders 140 and 234.

Upon energizing pump 14 (see FIG. 1) or the equivalent, air will flow into plenum 88 through passageway 78, as depicted by arrow 18. The air from the plenum will flow through a plurality of passageways, such as passageways 92, 96, into space 262 intermediate cylinder 140 and dielectric cylinder 146 and space 264 intermediate dielectric cylinder 146 and cylinder 62. Air will outflow through a plurality of passageways 118, 122 into plenum 116. Similarly, air from plenum 88 will flow through passageways 250, 252 into space 266 intermediate cylinder 62 and dielectric cylinder 230 and into space 268 intermediate dielectric cylinder 230 and cylinder 234. Air will outflow through a plurality of passageways 246, 248 into plenum 116. The air will be exhausted from plenum 116 through passageway 88, as depicted by arrow 24. With the application of a voltage potential between cylinder 62 and each of cylinders 140, 234, electrostatic discharges will occur between cylinders 140, 62 and between cylinders 62, 234. These electrostatic discharges will cause conversion of oxygen molecules in the air flowing therepast into ozone molecules. Accordingly, the air entering plenum 116 will include ozone and the ozonated air will outflow through passageway 88.

1. An ozone generator for producing ozone enriched air, said ozone generator comprising in combination:
a) a first electrode comprising a first cylinder of electrically conductive material;
b) a second electrode comprising a second cylinder generally concentric with said first cylinder;
c) first and second blocks disposed at opposed ends of said first and second cylinders adapted to channel a flow of air intermediate said first and second cylinders; and
d) a source of electrical power for generating an electrostatic discharge between said first and second cylinders to convert some molecules of oxygen to molecules of ozone.

2. An ozone generator as set forth in claim 1 including a pump for producing the flow of air.

3. An ozone generator as set forth in claim 1 including a cylinder of dielectric material disposed generally concentric with and intermediate said first and second cylinders.

4. An ozone generator as set forth in claim 1 including an electrically conductive rod extending through said first cylinder for urging said first and second blocks to capture and retain first and second cylinders therebetween.

5. An ozone generator as set forth in claim 4 including a boss of electrically conductive material in engagement with said rod and electrically conductive means for electrically connecting said rod with said first cylinder.

6. An ozone generator as set forth in claim 5 wherein said source of electrical power includes a first clip for electrically engaging and mechanically removably retaining said boss and a second clip for electrically engaging and mechanically removably retaining said second cylinder.

7. An ozone generator as set forth in claim 6 including first and second end caps associated with said first and second blocks, respectively, for channeling the flow of air associated with said first and second blocks.

8. An ozone generator, said ozone generator comprising in combination:
a) a source of high voltage electricity sufficient to generate an electrostatic discharge;
b) a module for generating ozone in response to electrostatic discharges, said module comprising in combination a first cylinder adapted to serve as a first electrode, a second cylinder disposed about said first cylinder, passageways for channeling a flow of oxygen molecule containing gas intermediate said first and second cylinders to subject the gas to electrostatic discharges and convert oxygen molecules of the gas into ozone molecules, a boss in electrical contact with said first cylinder;
c) a source of the gas for conveying the gas to said module; and
d) a first clip electrically connected to said high voltage source for removably engaging said boss to electrically connect said first cylinder with said high voltage source and a second clip electrically connected to said high voltage source for removably engaging said second cylinder.

9. An ozone generator as set forth in claim 8 including a dielectric cylinder disposed intermediate said first and second cylinders.

10. An ozone generator as set forth in claim 9 wherein said dielectric cylinder is glass tubing.

11. An ozone generator as set forth in claim 8 including a case for housing said high voltage source and said module.

12. An ozone generator as set forth in claim 8 including tubing for conveying the gas to said module and further tubing for conveying ozone enriched gas from said module to a point of use.

13. An ozone generator, said ozone generator comprising in combination:
a) a source of high voltage electricity sufficient to generate an electrostatic discharge;
b) a module for generating ozone in response to electrostatic discharges, said module comprising in combination a plurality of nested cylinders, a plurality of passageways for channeling a flow of oxygen molecule containing gas intermediate adjacent pairs of said plurality of cylinders to subject the gas to electrostatic discharges and to convert oxygen molecules of the gas into ozone molecules;
c) a source of the gas for conveying the gas to said module; and
d) an electrical conductor interconnecting alternate ones of said plurality of cylinders with said high voltage source and a further conductor interconnecting the remaining ones of said plurality of conductors, said high voltage source being adapted to provide electrostatic discharges between adjacent ones of said cylinders upon energization of said high voltage source.

14. An ozone generator as set forth in claim 13 including a dielectric cylinder disposed intermediate adjacent cylinders of said plurality of cylinders.

15. An ozone generator as set forth in claim 13 including a container for housing said high voltage source and said module and a pair of clips comprising said electrical conductor and said further electrical conductor for removably mounting said module in said container.

16. A method for generating ozone, said method comprising the steps of:
a) providing a source of high voltage electricity for generating electrostatic discharges;
b) mounting a first cylinder within and in spaced apart relationship to a second cylinder;
c) directing a flow of a gas containing oxygen molecules intermediate the first and second cylinders;
d) applying a high voltage from the high voltage source across the first and second cylinders to induce electrostatic discharges between the first and second cylinders and through the flowing gas to convert oxygen molecules to ozone molecules; and
e) channeling the ozone enriched gas to a point of use.

17. The method as set forth in claim 16 including the step of locating a dielectric cylinder intermediate the first and second cylinders.

18. The method as set forth in claim 16 wherein said step of mounting and applying are carried out within a module and including the step of removably mounting the module in engagement with a pair of clips.

19. The method as set forth in claim 18 wherein said step of applying is carried out by the clips.

20. The method as set forth in claim 16 including the step of providing at least one further cylinder about and in spaced apart relationship with the first and second cylinders and wherein said step of applying includes the step of electrically interconnecting alternate ones of the cylinders.
